(19) United States
(12) Patent Application Publication
(10) Pub. No.: US 2020/0260899 A1
(43) Pub. Date: Aug. 20, 2020

(54) WIRELESS INDUCTION HEATING COOKER AND WIRELESS INDUCTION HEATING SYSTEM INCLUDING SAME

(71) Applicant: LG Electronics Inc., Seoul (KR)

(72) Inventors: Hyeunsik NAM, Seoul (KR); Wan Soo KIM, Seoul (KR); Byungkyu PARK, Seoul (KR)

(21) Appl. No.: 16/796,586

(22) Filed: Feb. 20, 2020

(30) Foreign Application Priority Data
Feb. 20, 2019 (KR) 10-2019-0020143

(51) Int. Cl. A47J 27/086; H02J 50/10; H02J 50/40; H05B 6/12; H05B 3/00; F24C 7/08; A47J 27/08

(52) U.S. Cl. CPC A47J 27/086; H02J 50/10; H02J 50/40; H05B 6/1209; A47J 27/0815; H05B 6/1236; H05B 6/1245; F24C 7/08; A47J 27/0802; H05B 3/0014

(57) ABSTRACT

A wireless induction heating cooker a main body, a lid, an internal pot configured to be heated based on a first magnetic field generated by a heating coil of an induction heating apparatus, a first power receiving coil disposed at a bottom surface of the main body and configured to generate a first electric current based on the first magnetic field, a power transmitting coil disposed at a lateral surface of the main body and configured to receive the first electric current and generate a second magnetic field based on the first electric current, a second power receiving coil disposed at a lateral surface of the lid and configured to generate a second electric current based on induction by the second magnetic field, and a control module configured to determine a coupling state between the lid and the main body based on an amount of the second electric current.

### CROSS-REFERENCE TO RELATED APPLICATION

This application claims priority to and the benefit of Korean Patent Application No. 10-2019-0020143, filed on Feb. 20, 2019, the disclosure of which is incorporated herein by reference in its entirety.

### TECHNICAL FIELD

The present disclosure relates to a wireless induction heating cooker that can electrically determine whether a main body and a lid are normally coupled, and a wireless induction heating system including the wireless induction heating cooker.

### BACKGROUND

A cooking apparatus may include a rice cooker that can heat and cook various types of grain such as rice and that may include a main body and a lid. The lid may be coupled to the main body and seal an inside of the rice cooker. Heating and cooking operations of the rice cooker may be performed in a state in which the inside of the rice cooker is sealed.

In some examples, when a food item is heated and cooked in the rice cooker, an internal pressure in the rice cooker may rapidly increase. In some cases, when the lid and the main body are abnormally coupled, the lid may abnormally escape from the main body due to the pressure inside the rice cooker, which may cause an explosion or a fire.

FIG. 1 is a view illustrating a method of sensing locking of a lid of an electric pressure rice cooker in related art.

Referring to FIG. 1, a magnetic member 110′ is installed on one side of a locking ring 100′ that is swivably mounted onto the inside of the lid of the rice cooker, that is swiveled by a handle installed on the outside of the lid, and that locks or unlocks a main body and the lid of the rice cooker.

The magnetic member 110′ includes a plate-type bracket 111′ extending in a circular center direction of the locking ring 100′ at one side of an inner circumferential surface of the locking ring 100′, a magnet 112′ mounted onto an upper surface of the bracket 111′, and a hook 113′ allowing the magnet 112′ to be coupled to the bracket 111′.

A reed switch may be installed near the magnetic member 110′ and is operated by magnetic properties of the magnet 112′. Specifically, when the locking ring 100′ is swiveled in one direction and then the lid is locked, the reed switch is connected by the magnetic properties of the magnet 112′, and, when the locking ring 100′ is swiveled in the other direction and then the lid is unlocked, the reed switch is not affected by the magnetic properties of the magnet 112′ and is unconnected.

A controller may be electrically connected with the reed switch and determine locking of the lid based on whether the reed switch is connected.

In some cases, where the rice cooker includes an additional component such as the magnetic member 110′ and the reed switch for sensing locking of the lid, an additional installation space may be needed and production costs of the rice cooker may increase.

In some cases, wires for an electric connection between the reed switch and the controller (e.g., a PCB) may be additionally required, which may decrease productivity of the rice cooker.

### SUMMARY

The present disclosure describes a wireless induction heating cooker that electrically determine whether a lid and a main body are normally coupled, and a wireless induction heating system including the wireless induction heating cooker.

The present disclosure also describes an induction heating apparatus that supplies a magnetic field to a wireless induction heating cooker through a heating coil, and a wireless induction heating system including a wireless induction heating cooker that uses a magnetic field generated in an area with low efficiency of delivery of heat to an internal pot among magnetic fields supplied through the heating coil as a power source for an internal electronic device.

The present disclosure further describes a wireless induction heating cooker that informs a user of an abnormal coupling between a main body and a lid, and a wireless induction heating system including the wireless induction heating cooker.

Objectives of the present disclosure are not limited to the above-described ones. Additionally, other objectives and advantages that have not been mentioned may be clearly understood from the following description and may be more clearly understood from implementations. Further, it will be understood that the objectives and advantages of the present disclosure may be realized via means and combinations thereof that are described in the appended claims.

According to one aspect of the subject matter described in this application, a wireless induction heating cooker is configured to operate on an induction heating apparatus. The wireless induction heating cooker includes a main body having an upper surface that defines an opening, a lid that is configured to rotate relative to the main body to thereby couple to the upper surface of the main body, an internal pot that is configured to be received in the main body and that is configured to be heated by induction based on a first magnetic field being generated by a heating coil of the induction heating apparatus, a first power receiving coil disposed at a bottom surface of the main body and configured to generate a first electric current based on induction by the first magnetic field, a power transmitting coil disposed at a lateral surface of the main body and configured to receive the first electric current induced to the first power receiving coil and to generate a second magnetic field based on receiving the first electric current, a second power receiving coil disposed at a lateral surface of the lid and configured to generate a second electric current based on induction by the second magnetic field, and a control module that is configured to determine a coupling state between the lid and the main body based on an amount of the second electric current induced to the second power receiving coil.

Implementations according to this aspect may include one or more of the following features. For example, the wireless induction heating cooker may further include a first coupling ring disposed at the upper surface of the main body, and a second coupling ring that is disposed at a lower surface of the lid and that is configured to rotate relative to the first coupling ring to thereby couple to the first coupling ring. In some examples, the first coupling ring may define a groove that is depressed from the upper surface of the main body, and the second coupling ring may include a protrusion that protrudes from the lower surface of the lid and that is configured to be inserted into the groove of the first coupling ring and then rotated relative to the first coupling ring to thereby couple the second coupling ring to the first coupling ring.

In some implementations, the first coupling ring may include a plurality of guide jaws, and the second coupling ring may include a plurality of stopping jaws that are configured to engage with the plurality of guide jaws based on the second coupling ring being inserted into the groove of the first coupling ring and rotated relative to the first coupling ring. In some implementations, the first power receiving coil may be arranged in parallel to the heating coil and face a lower portion of an edge area of the internal pot.

In some implementations, the lid may include one or more electronic devices, and the second power receiving coil may be configured to supply the second electric current to at least one of the one or more electronic devices. For instance, the one or more electronic devices in the lid may include at least one of a control module, a communication module, a display module, a steam discharge module, or a battery.

In some implementations, the wireless induction heating cooker may further include a power conversion circuit configured to convert the first electric current induced to the first power receiving coil and to supply the converted first electric current to the power transmitting coil.

In some implementations, the power transmitting coil may be disposed at an upper portion of the main body and extends along an outer surface of the main body, where the power transmitting coil has a first length along the outer surface of the main body. The second power receiving coil may extend along an outer surface of the lid, the second power receiving coil having a second length along the outer surface of the lid.

In some implementations, the power transmitting coil may extend along a cylindrical surface of the main body and be disposed within an area defined by a first central angle with respect to a center of the main body, and the second power receiving coil may extend along a cylindrical surface of the lid and be disposed within an area defined by a second central angle with respect to a center for the lid.

In some implementations, sizes of the power transmitting coil and the second power receiving coil may be identical to each other, and shapes of the power transmitting coil and the second power receiving coil may be identical to each other.

In some implementations, the second power receiving coil and the power transmitting coil may be configured to, based on the lid rotating relative to the main body, overlap with each other and define an overlapped area. In some examples, the amount of the second electric current induced to the second power receiving coil may be configured to vary proportional to a surface area of the overlapped area.

In some implementations, the control module may be configured to, based on the amount of the second electric current being greater than or equal to a reference amount of electric current, determine that the coupling state is a normal state. The control module may be configured to, based on the amount of the second electric current being less than the reference amount of electric current, determine that the coupling state is an abnormal state.

In some implementations, the control module may be configured to: based on the amount of the second electric current corresponding to a maximum amount of electric current during a rotation of the lid relative to the main body, determine that the coupling state is a normal state; and based on the amount of the second electric current being less than the maximum amount of electric current, determine that the coupling state is an abnormal state. In some examples, the control module may be configured to, based on the coupling state corresponding to an abnormal state, supply an output control signal to the display module. The display module may be configured to output abnormality information according to the output control signal.

In some implementations, the wireless induction heating cooker may further include: a lateral surface heating coil that is disposed on an outer circumferential surface of the internal pot, that is connected to the first power receiving coil, and that is configured to heat the internal pot using the first electric current induced to the first power receiving coil.

In some implementations, the second power receiving coil may be configured to, based on the coupling state corresponding to a normal state, face the power transmitting coil in a vertical direction with respect to the bottom surface of the main body or in a circumferential direction along the lateral surface of the main body.

According to another aspect, a wireless induction heating system includes: an induction heating apparatus including a main printed circuit board (PCB) and a heating coil that is configured to generate a first magnetic field according to control by the main PCB, and a wireless induction heating cooker including a main body and a lid configured to rotate relative to the main body to thereby couple to the main body and to cook food items by induction based on the first magnetic field being generated by the heating coil. The wireless induction heating cooker is configured to determine a coupling state between the lid and the main body based on an amount of power transferred from the heating coil.

Implementations according to this aspect may include one or more of the following features or the features described above of the wireless induction heating cooker. For example, the wireless induction heating cooker may further include: an internal pot that is configured to be received in the main body and that is configured to be heated by induction based on the first magnetic field being generated by the heating coil of the induction heating apparatus, a first power receiving coil disposed at a bottom surface of the main body and configured to generate a first electric current based on induction by the first magnetic field, a power transmitting coil disposed at a lateral surface of the main body and configured to receive the first electric current induced to the first power receiving coil and generate a second magnetic field based on receiving the first electric current, a second power receiving coil disposed at lateral surface of the lid and configured to generate a second electric current based on induction by the second magnetic field, and a control module configured to determine the coupling state based on an amount of the second electric current induced to the second power receiving coil.

In some implementations, the wireless induction heating cooker may determine a coupling state of a lid based on an amount of power delivered to the lid at the time of a rotation coupling of the lid, thereby electrically finding out whether the lid and the main body are normally coupled.

In some implementations, the wireless induction heating cooker may drive an electronic device using electric currents induced to a coil placed in parallel with a heating coil at a lower portion of an edge area of an internal pot, thereby using a magnetic field generated in an area with low efficiency of delivery of heat to the internal pot as a power source for an internal electronic device.

In some implementations, at least one of the wireless induction heating cooker and the induction heating apparatus may output abnormality information visually when a coupling state of a lid is an abnormal state, thereby informing a user about an abnormal coupling between a main body and a lid.

In some implementations, the wireless induction heating cooker may electrically find out whether the lid and the main body are normally coupled without an additional physical component, thereby accurately detecting a coupling state of the lid with no increase in production costs and with no reduction in productivity.

In some implementations, the wireless induction heating cooker may use a magnetic field generated in an area with low efficiency of delivery of heat to the internal pot as a power source for an internal electronic device, thereby efficiently using power wirelessly supplied by the induction heating apparatus for cooking operations.

In some implementations, the wireless induction heating cooker may inform a user about an abnormal coupling between the main body and the lid, thereby preventing an explosion or a fire during cooking, which is caused by an abnormal coupling of the lid.

Detailed effects of the present disclosure are described together with the above-described effects in the detailed description of the disclosure.

### BRIEF DESCRIPTION OF THE DRAWING

FIG. 1 is a view illustrating an example of a method for sensing locking of a lid of an electric pressure rice cooker in related art.

FIG. 2 is a view illustrating an example of a wireless induction heating cooker configured to operate on an example induction heating apparatus.

FIG. 3 is an exploded view illustrating an example lid, an example internal pot and an example main body of the wireless induction heating cooker in FIG. 2.

FIG. 4 is a view illustrating an example of rotation-coupling of an example lid and an example main body.

FIGS. 5A and 5B are views illustrating examples of arrangement of an example first power receiving coil.

FIG. 6 is an inner block diagram illustrating an example of a control flow of the wireless induction heating cooker and the induction heating apparatus in FIG. 2.

FIG. 7 is a view illustrating an example of a second power receiving coil and a power transmitting coil.

FIGS. 8A and 8B are views illustrating example positions of the second power receiving coil relative to the power transmitting coil in FIG. 7 in which the positions change depending on whether the lid is rotation-coupled to the main body.

FIG. 9 is a view illustrating another example of a second power receiving coil and a power transmitting coil.

FIGS. 10A and 10B are views illustrating example positions of the second power receiving coil relative to the power transmitting coil in FIG. 9, in which the positions change depending on whether the lid is rotation-coupled to the main body.

FIG. 11 is a view illustrating an example of second power receiving coils and power transmitting coils.

FIG. 12 is a view illustrating an example of a wireless induction heating system.

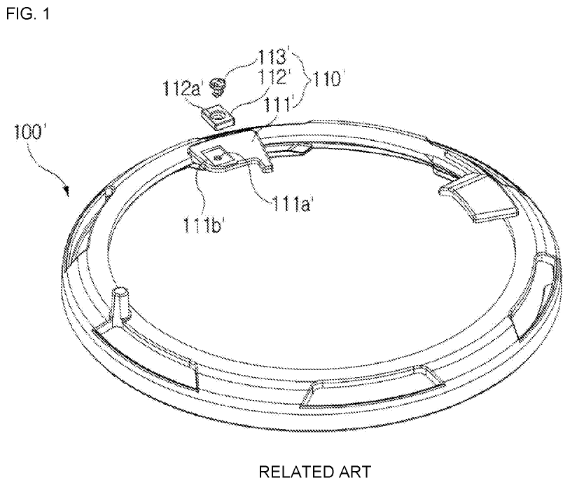

### DETAILED DESCRIPTION

The above-described aspects, features and advantages are specifically described with reference to the attached drawings hereunder such that one having ordinary skill in the art to which the present disclosure pertains may easily implement the technical spirit of the disclosure. In describing the disclosure, detailed description of known technologies in relation to the disclosure is omitted if it is deemed to make the gist of the present disclosure unnecessarily vague. Below, example implementations of the present disclosure are specifically described with reference to the attached drawings. Throughout the drawings, identical reference numerals denote identical or similar components.

The present disclosure relates to a wireless induction heating cooker that may electrically determine whether a main body and a lid are normally coupled.

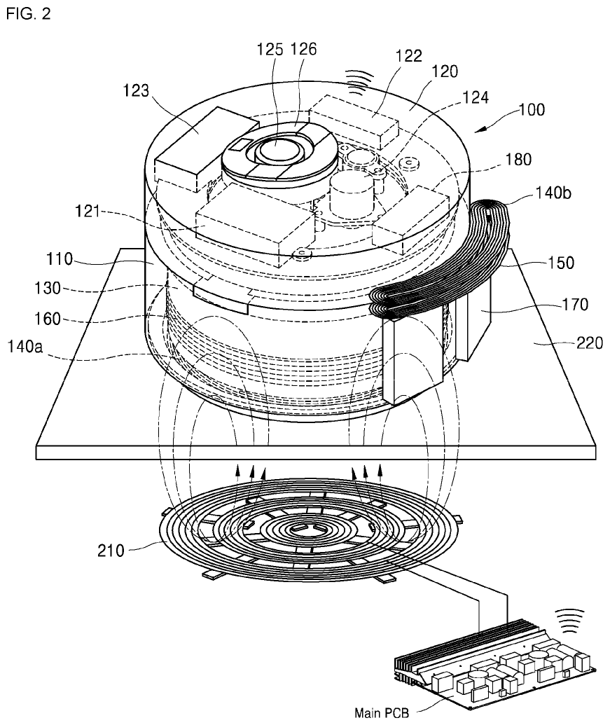

Below, an exemplary wireless induction heating cooker is described with reference to FIGS. 2 to 11.

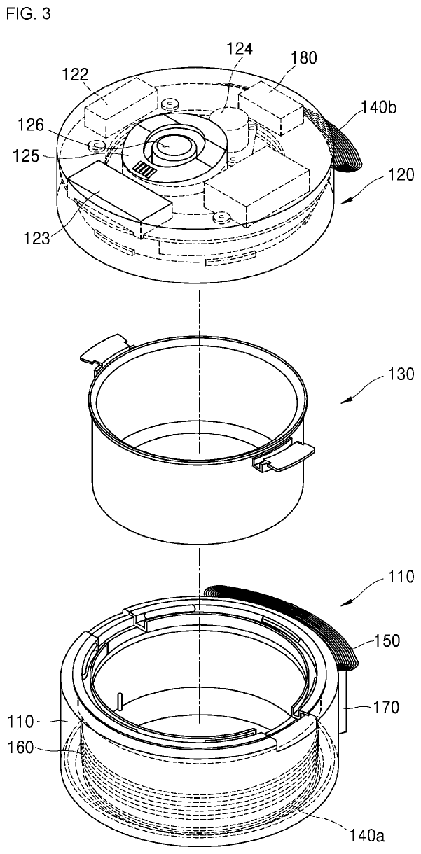

FIG. 2 is a view illustrating an example of a wireless induction heating cooker configured to operate on an induction heating apparatus, and FIG. 3 is a view separately illustrating an example lid, an example internal pot, and an example main body of the wireless induction heating cooker in FIG. 2.

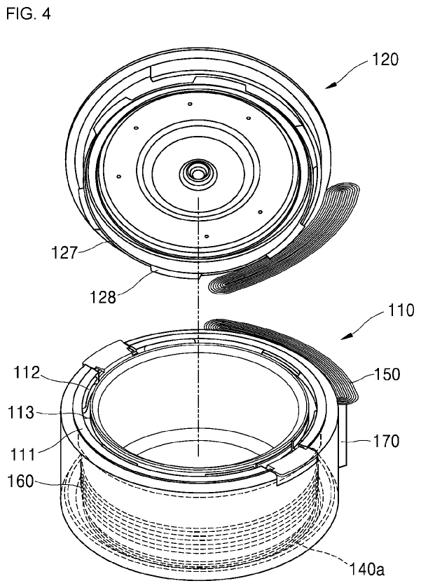

FIG. 4 is a view illustrating an example of a rotation-coupling of an example lid and an example main body.

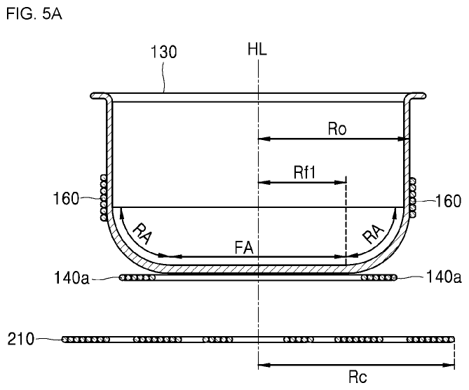

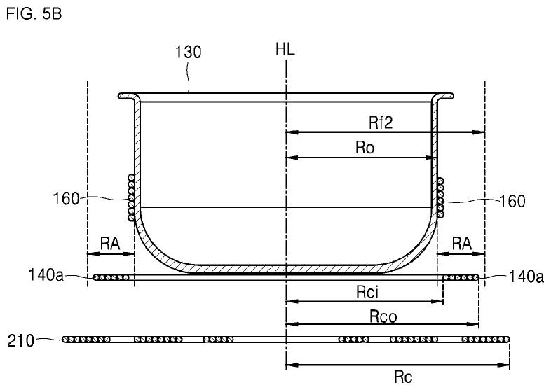

FIGS. 5A and 5B are views illustrating examples of arrangement of a first power receiving coil.

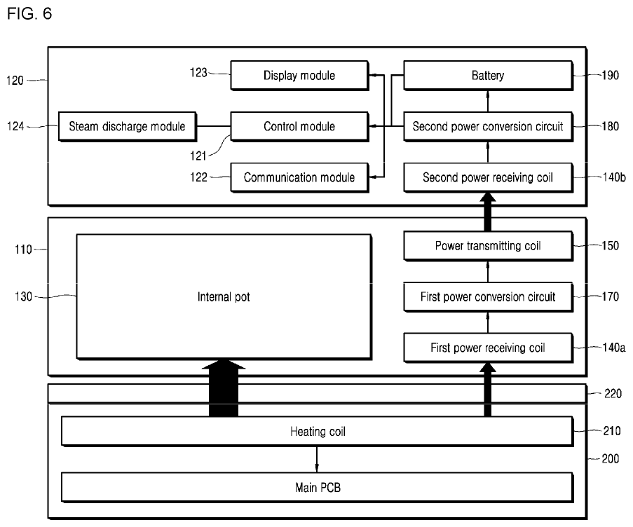

FIG. 6 is an inner block diagram illustrating an example of a control flow of the wireless induction heating cooker and the induction heating apparatus in FIG. 2.

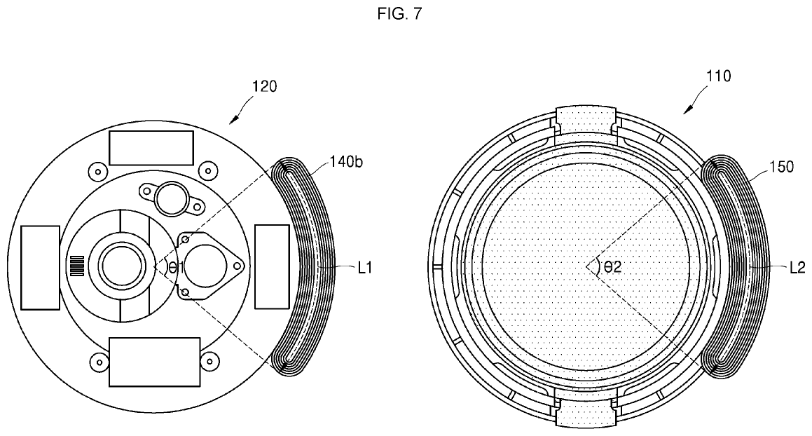

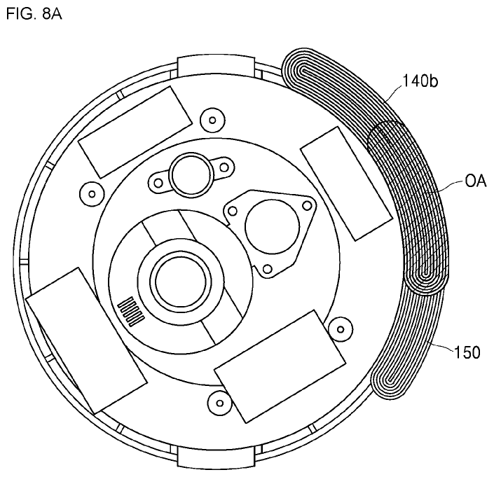

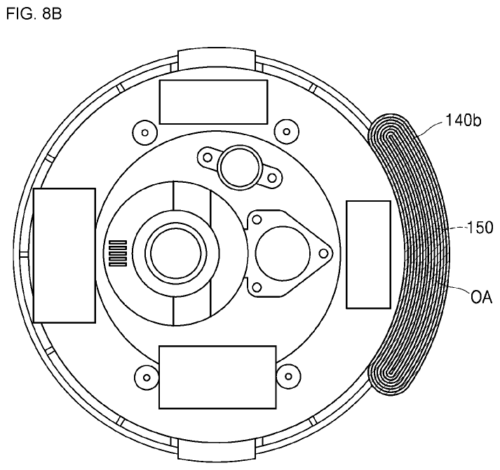

FIG. 7 is a view illustrating an example of a second power receiving coil and a power transmitting coil, and FIGS. 8A and 8B are views illustrating example positions of the second power receiving coil relative to the power transmitting coil in FIG. 7, in which the positions may change depending on whether the lid is rotation-coupled to a main body.

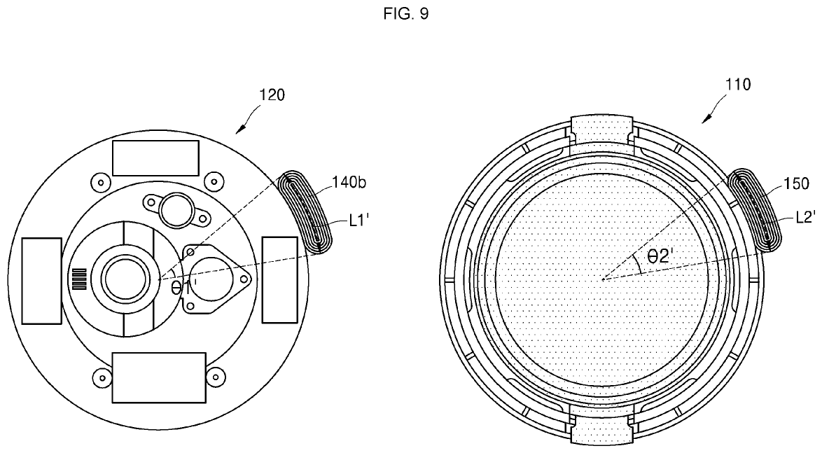

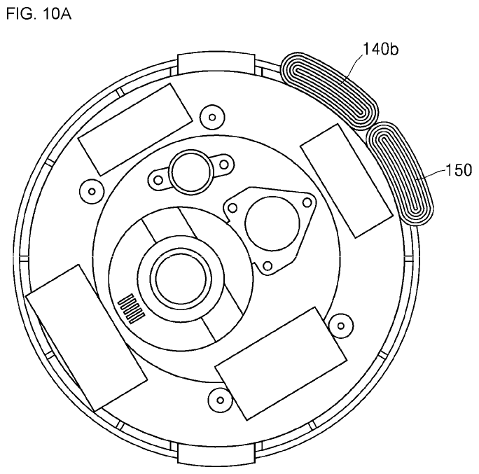

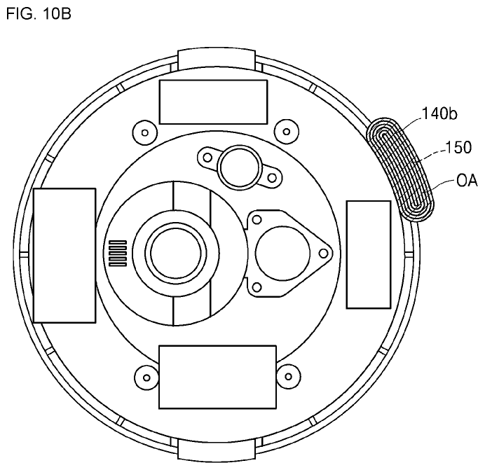

FIG. 9 is a view illustrating another example of a second power receiving coil and a power transmitting coil, and FIGS. 10A and 10B are views illustrating example positions of the second power receiving coil relative to the power transmitting coil in FIG. 9, in which the positions change depending on whether the lid is rotation-coupled to a main body.

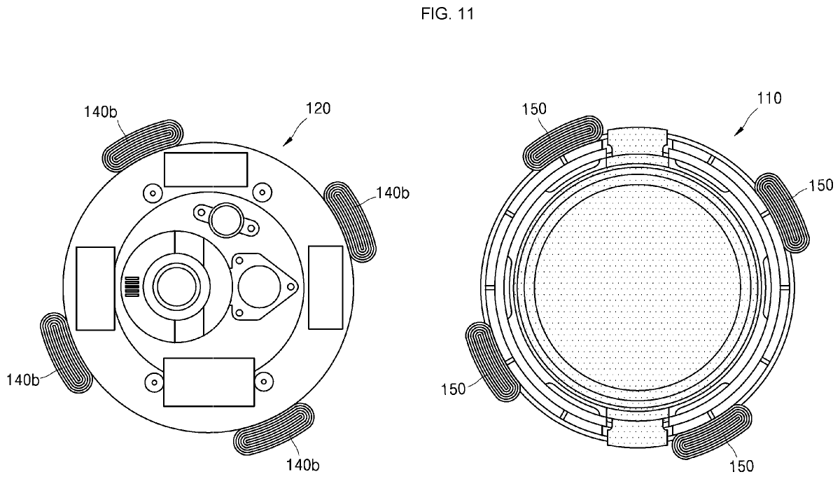

FIG. 11 is a view illustrating an example of second power receiving coils and power transmitting coils.

Referring to FIGS. 2 and 3, the exemplary wireless induction heating cooker 100 may include a main body 110, a lid 120, and an internal pot 130. The main body 110 may be provided with a first power receiving coil 140a and a power transmitting coil 150, and the lid 120 may be provided with a second power receiving coil 140b. In some implementations, the lid 120 may include a control module 121, a communication module 122, a display module 123, a steam discharge module 124, a pressure weight 125, and a noise reduction module 126.

The wireless induction heating cooker 100 illustrated in FIGS. 2 and 3 is provided as an implementation, and components of the wireless induction heating cooker 100 are not limited to those of the implementation illustrated in FIGS. 2 and 3. When necessary, some components may be added, modified or removed.

The wireless induction heating cooker 100 may operate on any induction heating apparatus 200 that heats an item subject to heating through the process of electromagnetic induction.

The wireless induction heating cooker 100, as illustrated in FIG. 2, may operate in the state of being placed on an upper plate 220 of any induction heating apparatus 200 provided with a heating coil 210. Specifically, the wireless induction heating cooker 100 may operate in the state of being placed on the upper plate 220 on a perpendicular line of the heating coil 210.

In some implementations, the induction heating apparatus 200 may include a main PCB that may supply electric currents to the heating coil 210, and a magnetic field may be generated in the heating coil 210. The magnetic field generated in the heating coil 210 may induce electric currents to the below-described internal pot 130 and the first power receiving coil 140a.

The main body 110, which is a case supporting a lower portion and a lateral portion of the wireless induction heating cooker 100, may have a cylinder shape the upper portion of which is opened. An item subject to cooking may be cooked in the main body 110. Specifically, the main body 110 stores the internal pot 130 and various types of grain such as rice may be heated and cooked in the internal pot 130.

The internal pot 130 is stored in the main body 110 and may be heated by a magnetic field generated in the heating coil 210 of the induction heating apparatus 200. The internal pot 130 may have a shape corresponding to the shape of the main body 110. For example, when the main body 110, as illustrated in FIG. 3, has a cylinder shape, the internal pot 130 may also have a cylinder shape the upper surface of which is opened.

When the wireless induction heating cooker 100 is placed at an upper portion of the induction heating apparatus 200, a lower surface of the internal pot 130, and the heating coil 210 may be placed to face each other with a bottom surface of the main body 110 therebetween. When electric currents flow through the heating coil 210, a magnetic field generated in the heating coil 210 may induce electric currents to the internal pot 130, and Joule's heat may be generated in the internal pot 130 by the induced currents.

For generation of induced currents, the internal pot 130 may include any material having magnetic properties. The internal pot 130, for example, may include cast iron including iron (Fe), or clad in which iron (Fe), aluminum (Al), and stainless steel and the like are welded.

In some implementations, a surface area of a bottom surface of the internal pot 130 may be smaller than a surface area of the heating coil 210. In other words, when the heating coil 210 is a planar circular coil and the internal pot 130 has a cylinder shape, a radius of the bottom surface of the internal pot 130 is smaller than a coil radius (Rc) of the heating coil 210. In some implementations, where the surface area of the bottom surface of the internal pot 130 is designed to be smaller than the surface area of the heating coil 210 as described above, a magnetic field generated in the heating coil 210 may all be delivered to the bottom surface of the internal pot 130 without a leak in an area in which the internal pot 130 is placed.

The lid 120, which is a case sealing an upper portion of the wireless induction heating cooker 100, may be rotation-coupled to an upper surface of the main body 110. Specifically, the lid 120 may be rotation-coupled to the upper surface of the main body 110 and may be attached to and detached from the main body 110.

The rotation-coupling may be any coupling by which the lid 120 is coupled to or decoupled from the main body 110 by horizontally rotating with respect to the upper surface of the main body 110. The rotation-coupling, for example, may be any coupling by which a coupling projection and a coupling groove provided respectively at any two objects are horizontally engaged and by which the two objects are coupled.

As an example, the main body 110 may be provided with a first coupling ring 111 on the upper surface of the main body 110, and the lid 120 may be provided with a second coupling ring 127 on a lower surface of the lid 120. In this case, the lid 120 may be attached to and detached from the upper surface of the main body 110 through the rotation-coupling of the first coupling ring 111 and the second coupling ring 127.

Specifically, the first coupling ring 111 may be provided along a perimeter of the upper surface of the main body 110 in a ring shape, and the second coupling ring 127 may be provided along a perimeter of the lower surface of the lid 120 in a ring shape. Any one of the first coupling ring 111 and the second coupling ring 127 may be inserted into the other one and then rotated such that the first coupling ring 111 and the second coupling ring 127 are rotation-coupled.

As an example, as illustrated in FIG. 4, the first coupling ring 111 may be depressed from the upper surface of the main body 110, and the second coupling ring 127 may protrude from the lower surface of the lid 120. In other words, the first coupling ring 111 may include a groove 113 that is depressed downwards, and the second coupling ring 127 may protrude downwards. The second coupling ring 127 may be inserted into the groove 113 of the first coupling ring 111.

The second coupling ring 127 may be inserted into the groove 113 of the first coupling ring 111, and then may be horizontally rotated with respect to the first coupling ring 111 and may be rotation-coupled to the first coupling ring 111. To this end, each of the first coupling ring 111 and the second coupling ring 127 may include a plurality of members that are engaged with each other when the second coupling ring 127 is rotated.

For example, the first coupling ring 111 may include a plurality of guide jaws, and the second coupling ring 127 may include a plurality of stopping jaws 128, as illustrated in FIG. 4. When the second coupling ring 127 is inserted into the groove 113 of the first coupling ring 111 and then is rotated, the plurality of stopping jaws 128 formed at the second coupling ring 127 may be engaged respectively with the plurality of guide jaws 112 formed at the first coupling ring 111.

Specifically, the plurality of guide jaws 112 may protrude in one horizontal direction (e.g., an inward direction) and may be formed at the first coupling ring 111. The plurality of stopping jaws 128 may protrude in the other horizontal direction (e.g., an outward direction) and may be formed at the second coupling ring 127. The guide jaw 112 and the stopping jaw 128 may be engaged with each other radially when the second coupling ring 127 is rotated with respect to the first coupling ring 111.

In other words, in a state in which the guide jaw 112 and the stopping jaw 128 are arranged radially not to meet each other, the second coupling ring 127 may be inserted into the first coupling ring 111. When the second coupling ring 127 is rotated in the state of being inserted into the first coupling ring 111, the stopping jaw 128 may be moved radially with respect to the guide jaw 112, and, when the second coupling ring 127 is rotated with respect to the first coupling ring 111 by a specific angle, the plurality of guide jaws 112 may be completely engaged with the plurality of stopping jaws 128.

When the guide jaw 112 is engaged with the stopping jaw 128, as long as the second coupling ring 127 is not rotated in an opposite direction, the lid 120 may not be separated from the main body although an external force is applied perpendicularly (upwards or downwards) to the lid 120 and the main body 110.

With the above-described structure, the lid 120 may be completely separated from the main body. The lid 120 may be readily cleaned in relation to use of the wireless induction heating cooker 100.

The process in which the lid 120 is rotation-coupled to the main body 110 is described above with reference to the structure illustrated in FIG. 4. However, the lid 120 of the disclosure may be rotation-coupled to the main body 110 through various structures used in the art to which the disclosure pertains, in addition to the structure illustrated in FIG. 4.

The lid 120, as illustrated in FIG. 2, may be provided with at least one of electronic devices. The lid 120, for example, may include a control module 121 controlling some or entire operations of the wireless induction heating cooker 100, a communication module 122 performing data communication with the main PCB of the induction heating apparatus 200, a display module 123 visually outputting state information of the wireless induction heating cooker 100 and the like. In some examples, the lid 120 may further include a battery 190 for supplying a power source to the above-described control module 121, communication module 122, and display module 123.

The control module 121, the communication module 122, and the display module 123 may be implemented as a printed circuit board (PCB) including a plurality of integrated circuits (IC). In some cases, each of the control module 121, the communication module 122, and the display module 123 may be disposed on one PCB. For examples, in some examples, a controller may include all or some of the control module 121, the communication module 122, and the display module 123. In some cases, the control module 121, the communication module 122, and the display module 123 may be disposed in two or more PCBs.

The lid 120 may also be provided with a pressure weight 125 for maintaining internal pressure of the wireless induction heating cooker 100 at a constant level, and a noise reduction module 126 in which a sound absorption member is built to reduce noise when steam is discharged. In addition, the lid 120 may be provided with a steam discharge module 124 (e.g., a solenoid valve) for discharging internal steam of the wireless induction heating cooker 100 outwards according to a specific control signal.

The first power receiving coil 140a may be provided on the bottom surface of the main body 110, and electric currents may be induced to the first power receiving coil 140a by a magnetic field generated in the heating coil 210.

The first power receiving coil 140a may have a ring shape with a predetermined inner diameter and a predetermined outer diameter, and may be placed at any position of the bottom surface of the main body 110. In some implementations, the first power receiving coil 140a may be placed in parallel with the heating coil 210 at a lower portion of an edge area of the internal pot 130 such that efficiency of heating of the internal pot 130 is maximized through the process of electromagnetic induction.

The edge area, which is an area defined in a radial direction with respect to a central perpendicular line of the internal pot 130, may be an area adjacent to a cylindrical surface of the internal pot 130. In other words, the edge area may be an area adjacent to a circumference of the internal pot 130 when the internal pot 130 is seen from its top. Below, the edge area of the internal pot 130 is described with reference to FIGS. 5A and 5B.

Referring to FIG. 5A, an edge portion (referred to as “rounded portion”) of the bottom surface of the internal pot 130 may be rounded such that an item subject to cooking is easily taken out after cooking of the item subject to cooking is completed. In some examples, the bottom surface of the internal pot 130 may include a flat plate area (FA) that is a flat portion and that is formed in parallel with the heating coil 210, and a rounded portion that is rounded at a connected portion of the bottom surface and the lateral surface of the internal pot 130.

As an example, the edge area (RA) of the internal pot 130 may be the same as the rounded portion. In this case, the first power receiving coil 140a may be placed horizontally at the edge area (RA) of the internal pot 130, i.e., a lower portion of the rounded portion.

Specifically, the flat plate area (FA) of the bottom surface of the internal pot 130 may be formed within a first reference radius (Rf1) with respect to the central perpendicular line (HL) of the internal pot 130, and the edge area (RA) of the bottom surface of the internal pot 130 may be formed between the first reference radius (Rf1) and an outer diameter (Ro) of the internal pot 130. In this structure, the first power receiving coil 140a may be placed in an area between the first reference radius (Rf1) and the outer diameter (Ro) of the internal pot 130, which is the edge area (RA).

A distance between the edge area (RA) and the heating coil 210 may be greater than a distance between the flat plate area (FA) and the heating coil 210. In some examples, an amount of heat delivered by a magnetic field generated in the heating coil 210 may be smaller in the edge area (RA) than in the flat plate area (FA).

The first power receiving coil 140a, as described above, may be placed at the lower portion of the edge area (RA) to which a relatively small amount of heat is delivered, thereby receiving power from the heating coil 210 without largely reducing an entire amount of heat delivered to the internal pot 130.

As another example, referring to FIG. 5B, the edge area (RA) of the internal pot 130 may be perpendicularly formed outside of the internal pot 130. Specifically, the edge area (RA) of the internal pot 130 may be formed between the outer diameter (Ro) of the internal pot 130, and a second reference radius (Rf2) larger than the outer diameter (Ro) of the internal pot 130.

In some examples, the first power receiving coil 140a may be placed outside of the internal pot 130 when the internal pot 130 is seen from its top. That is, the first power receiving coil 140a having a structure, in which the inner diameter (Rci) of the first power receiving coil 140a is larger than the outer diameter (Ro) of the internal pot 130, may be placed at the lower portion of the internal pot 130.

However, the outer diameter (Rco) of the first power receiving coil 140a may be smaller than the coil radius (Rc) of the heating coil 210 such that induced currents are efficiently generated in the first power receiving coil 140a.

In other words, as illustrated in FIG. 5B, the inner diameter (Rci) of the first power receiving coil 140a may be designed to be larger than the outer diameter (Ro) of the internal pot 130, and the outer diameter (Rco) of the first power receiving coil 140a may be designed to be smaller than the coil radius (Rc) of the heating coil 210. In some examples, an area formed by the first power receiving coil 140a may all be perpendicularly included in an area formed by the heating coil 210.

Thus, in the implementation illustrated in FIG. 5B, a magnetic field generated in the heating coil 210 may be delivered to the first power receiving coil 140a without a leak within an area in which the first power receiving coil 140a is placed.

The first power receiving coil 140a, as described above, is placed at the lower portion of the edge area (RA) in which a perpendicular delivery of heat to the internal pot 130 does not occur. In some examples, the first power receiving coil 140a may receive power from the heating coil 210 without reducing an amount of heat delivered to the internal pot 130.

The present disclosure, as described above, may use a magnetic field generated in an area having low efficiency of delivery of heat to the internal pot 130 as a power source for an internal electronic device according to a below-described method, thereby efficiently using power supplied wirelessly by the induction heating apparatus 200 for cooking operations.

A lateral surface heating coil 160 may be placed perpendicularly on an outer circumferential surface of the internal pot 130, may be connected to the first power receiving coil 140a, and may heat the internal pot 130 using electric currents induced to the first power receiving coil 140a.

Referring back to FIGS. 2, 5A and 5B, the lateral surface heating coil 160 may be wound along the outer circumferential surface of the internal pot 130, and, In some examples, may be placed in close contact with the outer circumferential surface of the internal pot 130. If the main body 110 is provided with an internal pot support member for supporting the internal pot 130 in the main body 110, and the internal pot support member supports the outer circumferential surface of the internal pot 130 as well as the bottom surface of the internal pot 130, the lateral surface heating coil 160 may also be placed on the internal pot support member.

The lateral surface heating coil 160 may be perpendicularly placed. Specifically, the lateral surface heating coil 160 is a coil having a plurality of layers according to the number of its turns, and each of the layers may be perpendicularly arranged in parallel along the outer circumferential surface of the internal pot 130.

The lateral surface heating coil 160 may be electrically connected with the first power receiving coil 140a. In other words, one end of the lateral surface heating coil 160 may be connected with one end of the first power receiving coil 140a. Thus, the first power receiving coil 140a and the lateral surface heating coil 160 may be implemented as a single metallic wire, and, in this case, the first power receiving coil 140a and the lateral surface heating coil 160 may be distinguished according to their positions and functions.

The lateral surface heating coil 160 may be electrically connected with the first power receiving coil 140a, and electric currents induced to the first power receiving coil 140a may flow through the lateral surface heating coil 160. When electric currents flow through the lateral surface heating coil 160, a magnetic field may be generated in the lateral surface heating coil 160, and the magnetic field generated in the lateral surface heating coil 160 may induce electric currents to the outer circumferential surface of the internal pot 130 and may heat the internal pot 130, specifically, the lateral surface of the internal pot 130.

The present disclosure, as described above, may use a magnetic field generated in an area having low efficiency of delivery of heat to the bottom surface of the internal pot to heat the lateral surface of the internal pot, thereby efficiently using power output by the heating coil in heating the internal pot.

The power transmitting coil 150 may be provided on one lateral surface of the main body 110, and may receive the electric currents induced to the first power receiving coil 140a and generate a magnetic field.

Referring to FIGS. 2 and 3, the power transmitting coil 150 may be supported by any support member and may be fixed on one lateral surface of the main body 110. The power transmitting coil 150 may be placed in close contact with the lateral surface of the main body 110 such that volume of the wireless induction heating cooker 100 is minimized.

The power transmitting coil 150 may have a flat plate shape and may be placed horizontally on the lateral surface of the main body 110 to face the below-described second power receiving coil 140b. That is, the power transmitting coil 150 may be placed perpendicularly on the lateral surface of the main body 110.

The power transmitting coil 150 may be electrically connected with the first power receiving coil 140a. The electric currents induced to the first power receiving coil 140a may be supplied to the power transmitting coil 150 as the power transmitting coil 150 is electrically connected with the first power receiving coil 140a. When the electric currents flow through the power transmitting coil 150, a magnetic field may be generated in the power transmitting coil 150.

The wireless induction heating cooker 100 may further include a first power conversion circuit 170 that converts the electric currents induced to the first power receiving coil 140a and that supplies the converted electric currents to the power transmitting coil 150.

Referring to FIG. 2, the first power conversion circuit 170 may be provided on one lateral surface of the main body 110 in the form of a packaged integrated circuit. Specifically, the first power conversion circuit 170 may be fixedly provided on one lateral surface of the main body 110 at a lower portion of the power transmitting coil 150.

Referring to FIG. 6, an input terminal of the first power conversion circuit 170 may be connected to the first power receiving coil 140a, and an output terminal of the first power conversion circuit 170 may be connected to the power transmitting coil 150. In some examples, the first power conversion circuit 170 may convert the electric currents induced to the first power receiving coil 140a into stable high-frequency currents and may supply the same to the power transmitting coil 150.

An amount of electric currents induced to the first power receiving coil 140a may vary depending on an output from the heating coil 210, load of the internal pot 130 (moisture included in an item subject to cooking, an amount of an item subject to cooking, and the like). In some implementations, an amount of electric currents induced to the first power receiving coil 140a may also vary depending on a degree of matching between coils, which is determined based on a relative position of the heating coil 210 and the wireless induction heating cooker 100.

The first power conversion circuit 170, as described above, may store the electric currents induced to the first power receiving coil 140a as a predetermined voltage to minimize changes in the amount of the electric currents, and may convert the stored voltage into stable high-frequency currents and supply the stable high-frequency currents to the power transmitting coil 150. In some examples, the power transmitting coil 150 may generate a magnetic field by receiving the high-frequency currents.

The second power receiving coil 140b may be provided on one lateral surface of the lid 120.

Referring to FIGS. 2 and 3, the second power receiving coil 140b may be supported by any support member and may be fixed on one lateral surface of the lid 120. The second power receiving coil 140b may be placed in close contact with the lateral surface of the lid 120 such that volume of the wireless induction heating cooker 100 is minimized.

Specifically, like the power transmitting coil 150, the second power receiving coil 140b may have a flat plate shape and may be placed horizontally on the lateral surface of the lid 120 to face the power transmitting coil 150. That is, the second power receiving coil 140b may be placed perpendicularly on the lateral surface of the lid 120.

When electric currents flow through the power transmitting coil 150 in the state in which the second power receiving coil 140b and the power transmitting coil 150 face each other, electric currents may be induced to the second power receiving coil 140b by a magnetic field generated in the power transmitting coil 150.

In this case, an amount of the electric currents induced to the second power receiving coil 140b may differ depending on an arrangement of the power transmitting coil 150 and the second power receiving coil 140b. A specific arrangement of the power transmitting coil 150 and the second power receiving coil 140b, and a process of delivering power according to a relative position relation of each of the coils are described hereunder with reference to FIGS. 7 to 11.

The second power receiving coil 140b may supply electric currents induced by a magnetic field generated in the power transmitting coil 150 to at least one of electronic devices provided at the lid 120.

Referring to FIGS. 2 and 6, the second power receiving coil 140b may be electrically connected to a plurality of electronic devices in the lid 120. In some examples, each of the electronic devices in the lid 120 may receive induced currents generated in the second power receiving coil 140b as a power source.

The plurality of electronic devices may operate based on the power source supplied by the second power receiving coil 140b. For example, the control module 121 may control entire operations (e.g., a discharge and a cutoff of steam of the steam discharge module 124) of the wireless induction heating cooker 100 using the power source supplied by the second power receiving coil 140b, and the communication module 122 may perform data communication with a main PCB of the induction heating apparatus 200 using the power source supplied by the second power receiving coil 140b. In some implementations, the display module 123 may visually output state information of the wireless induction heating cooker 100 using the power source supplied by the second power receiving coil 140b.

The wireless induction heating cooker 100, as illustrated in FIG. 2, may further include a second power conversion circuit 180 that delivers electric currents, induced to the second power receiving coil 140b, to an electronic device in the lid 120.

Like the first power conversion circuit 170, the second power conversion circuit 180 may be provided in the lid 120 in the form of a packaged integrated circuit. Referring to FIG. 6, an input terminal of the second power conversion circuit 180 may be connected to the second power receiving coil 140b, and an output terminal of the second power conversion circuit 180 may be connected to each of the electronic devices in the lid 120.

The second power conversion circuit 180 may convert electric currents induced to the second power receiving coil 140b into an alternating current (AC) voltage having a predetermined-frequency or into a direct current (DC) voltage having a predetermined-magnitude, and may supply the predetermined-frequency AC voltage and the predetermined-magnitude DC voltage to each electronic device.

For example, AC currents may be induced to the second power receiving coil 140b, and each electronic device in the lid 120 may receive the predetermined-frequency AC voltage or the predetermined-magnitude DC voltage as a power source to perform operations, according to its specification.

The second power conversion circuit 180 may store the electric currents induced to the second power receiving coil 140b as a DC voltage, may convert the stored DC voltage into a predetermined-frequency AC voltage adequate for specifications of each electronic device, and may output the predetermined-frequency AC voltage. Additionally, the second power conversion circuit 180 may store the electric currents induced to the second power receiving coil 140b as a DC voltage, may increase or decrease a voltage of the stored DC voltage, and may output a predetermined-magnitude DC voltage adequate for specifications of each electronic device. In some examples, each electronic device may operate using a power source and voltage adequate for its specifications.

Referring back to FIG. 6, the exemplary wireless induction heating cooker 100 may further include a battery 190 that stores the electric currents induced to the second power receiving coil 140b.

The battery 190 may be provided in the lid 120 and may store the electric currents induced to the second power receiving coil 140b as reserved power. To this end, the second power conversion circuit 180 may supply the electric currents induced to the second power receiving coil 140b to the battery 190 to charge the battery 190.

The battery 190 may be connected to each of the electronic devices in the lid 120 and each electronic device may receive a power source from the battery 190 and may operate. For example, when each of the electronic devices operates by receiving a power source output from the second power conversion circuit 180 and, then when the second power conversion circuit 180 no longer outputs a power source, may operate by receiving a power source output from the battery 190.

Below, a specific arrangement of the power transmitting coil 150 and the second power receiving coil 140b, and a process of delivering power according to a relative position of each of the coils are described hereunder, with reference to FIGS. 7 to 11.

The power transmitting coil 150 is formed along an outer surface of the main body 110 on one lateral surface of the upper portion of the main body 110 to have a first length, and the second power receiving coil 140b may be formed along an outer surface of the lid 120 on one lateral surface of the lid 120 to have a second length.

The power transmitting coil 150 is placed along the outer surface of the main body 110. In some implementations, the power transmitting coil 150 may be formed to correspond to the shape of the main body 110. Additionally, the second power receiving coil 140b is placed along the outer surface of the lid 120. In some implementations, the second power receiving coil 140b may be formed to correspond to the shape of the lid 120.

Referring to FIGS. 7 and 9, when the main body 110, for example, has a cylinder shape, the power transmitting coil 150 may have a deformed oval shape that is formed along an outer circumferential surface of the main body 110 on one lateral surface of the upper portion of the main body 110. Specifically, a major axis of the power transmitting coil 150 has an oval shape with a circular arc shape in parallel with the outer circumferential surface of the main body 110. In this case, the major axis of the power transmitting coil 150 may have a first length (L1, L1′).

When the main body 110 has a rectangle pillar shape, the power transmitting coil 150 may have a rectangle shape that is formed along the outer surface of the main body 110 on one lateral surface of the upper portion of the main body 110. Specifically, the power transmitting coil 150 may have a rectangle shape in which a side extending horizontally is a straight line corresponding to the outer surface of the main body 110. In this case, a length of a side in close contact with the outer surface of the main body 110 may be the first length.

Referring back to FIGS. 7 and 9, when the lid 120 has a cylinder shape, the second power receiving coil 140b may have a deformed oval shape that is formed along an outer circumferential surface of the lid 120 on one lateral surface of a lower portion of the lid 120. Specifically, a major axis of the second power receiving coil 140b may have an oval shape with a circular arc shape in parallel with the outer circumferential surface of the lid 120. In this case, the major axis of the second power receiving coil 140b may have a second length (L2, L2′).

When the lid 120 has a rectangle pillar shape, the second power receiving coil 140b may have a rectangle shape that is formed along the outer surface of the lid 120 on one lateral surface of the lower portion of the lid 120. Specifically, the second power receiving coil 140b may have a rectangle shape in which a side extending horizontally is a straight line corresponding to the outer surface of the lid 120. In this case, a length of a side in close contact with the outer surface of the lid 120 may be the second length.

The first length (L1, L1′) and the second length (L2, L2′) may be determined in designing a wireless induction heating cooker according to the needs. In some implementations, the first length (L1, L1′) and the second length (L2, L2′), as described below, may be set to be the same to accurately detect whether the lid 120 is rotation-coupled.

When the main body 110 and the lid 120 have a cylinder shape respectively, the power transmitting coil 150 may be formed along a cylindrical surface of the main body 110 within a first central angle, and the second power receiving coil 140b may be formed along a cylindrical surface of the lid 120 within a second central angle.

The power transmitting coil 150 and the second power receiving coil 140b may be respectively placed on the outer surfaces of the cylinder-shaped main body 110 and the cylinder-shaped lid 120, i.e., along the cylindrical surfaces of the main body 110 and the lid 120.

The power transmitting coil 150, as illustrated in FIGS. 7 and 9, may have a deformed oval shape that is formed along the outer circumferential surface of the main body 110, and the second power receiving coil 140b may have a deformed oval shape that is formed along the outer circumferential surface of the lid 120.

In this case, the power transmitting coil 150 may be formed within the first central angle (81, 81′) with respect to a central perpendicular line of the wireless induction heating cooker 100, and the second power receiving coil 140b may be formed within the second central angle (82, 82′) with respect to the central perpendicular line of the wireless induction heating cooker 100.

For example, the power transmitting coil 150 may extend along a cylindrical surface of the main body 110 and may be disposed within an area defined by a first central angle (81, 81′) with respect to a center of the main body 110. The second power receiving coil 140b may extend along a cylindrical surface of the lid 120 and may be disposed within an area defined by a second central angle with respect to a center for the lid 120 (82, 82′).

In some implementations, unlike the power transmitting coil 150 and the second power receiving coil 140b in FIGS. 7 and 9, the power transmitting coil 150 and the second power receiving coil 140b may have a deformed rectangle shape in which a side extending horizontally comes into close contact with the main body 110 and the lid 120 respectively. Even in this case, the power transmitting coil 150 may be formed within the first central angle (81, 81′) with respect to the central perpendicular line of the wireless induction heating cooker 100, and the second power receiving coil 140b may be formed within the second central angle (82, 82′) with respect to the central perpendicular line of the wireless induction heating cooker 100.

The first central angle (81, 81′) and the second central angle (82, 82′) may be set in designing a wireless induction heating cooker according to the needs. In some implementations, the first central angle (81, 81′) and the second central angle (82, 82′), as described below, may be set to be the same to accurately detect whether the lid 120 is rotation-coupled.

In some examples, even when the lengths (the first length and the second length), at which the power transmitting coil 150 and the second power receiving coil 140b are formed, or the angles (the first central angel and the second central angle), at which the power transmitting coil 150 and the second power receiving coil 140b are formed, are the same, widths of the power transmitting coil 150 and the second power receiving coil 140b may differ.

As an example, when the lengths of the major axes of the two coils extending in a circular arc direction are the same in the case in which the power transmitting coil 150 and the second power receiving coil 140b have a deformed oval shape, lengths of short axes of the two coils, which are formed in a direction perpendicular to the circular arc direction, may differ.

As another example, even when the length of any side of each of the coils in close contact with the main body 110 and the lid 120 is the same in the case in which the power transmitting coil 150 and the second power receiving coil 140b have a deformed rectangle shape, a length of another side of each of the coils, which are formed in a direction perpendicular to the circular arc direction, may differ.

Further, the power transmitting coil 150 and the second power receiving coil 140b may have the completely same size and shape. In other words, when the power transmitting coil 150 and the second power receiving coil 140b have a deformed oval shape in the above-described implementation, curvature of the cylindrical surfaces of the ovals as well as the lengths of the major and short axes of the two coils may be the same. Furthermore, when the power transmitting coil 150 and the second power receiving coil 140b have a deformed rectangle shape, the length of each side of the two coils may be the same.

Additionally, the second power receiving coil 140b and the power transmitting coil 150 may form an overlapped area (OA) according to a degree to which the lid 120 rotates with respect to the main body 110. Specifically, the second power receiving coil 140b and the power transmitting coil 150 may form an overlapped area (OA) having a different surface area according to the degree of rotation-coupling described with reference to FIG. 4.

The overlapped area (OA) may be defined as an area in which the second power receiving coil 140b and the power transmitting coil 150 are overlapped when the wireless induction heating cooker 100 is seen from its top. For example, as the lid 120 is rotated relative to the main body 110, the overlapped area may increase or decrease. When the lid 120 is rotated relative to the main body 110 to a predetermined position, the overlapped area may be maximized. In some cases, the power receiving coil 140b may face and cover an entire upper surface of the power transmitting coil 150.

Referring to FIGS. 4 and 8A, when the second coupling ring 127 is inserted into the first coupling ring 111 in a state in which the plurality of guide jaws 112 and the plurality of stopping jaws 112 are placed not to meet each other radially, the second power receiving coil 140b and the power transmitting coil 150 may be partially overlapped. In other words, the second power receiving coil 140b and the power transmitting coil 150 may form an overlapped area (OA) having a predetermined width.

Referring to FIGS. 4 and 8A, when the second coupling ring 127 rotates in a state of being inserted into the first coupling ring 111, each stopping jaw 128 moves radially with respect to each guide jaw 112, and the plurality of stopping jaws 129 may be completely engaged with the plurality of guide jaws 112. In this case, the second power receiving coil 140b and the power transmitting coil 150 may be completely overlapped. In other words, the second power receiving coil 140b and the power transmitting coil 150 may form a maximum overlapped area (OA).

Referring back to FIG. 9, a length and an angle, at which the second power receiving coil 140b and the power transmitting coil 150 in FIG. 9 are formed, may be smaller than the length and angle illustrated in FIG. 7. For example, a central angle, at which the second power receiving coil 140b and the power transmitting coil 150 are formed, may be within the central angle of any one guide jaw 112 and any one stopping jaw 128 illustrated in FIG. 4.

Referring to FIGS. 4 and 10A, when the second coupling ring 127 is inserted into the first coupling ring 111 in the state on which the plurality of guide jaws 112 and the plurality of stopping jaws 128 are placed not to meet each other radially in the structure in FIG. 9, the second power receiving coil 140b and the power transmitting coil 150 may not be overlapped. In other words, the second power receiving coil 140b and the power transmitting coil 150 may not form an overlapped area (OA).

Referring to FIGS. 4 and 10B, when the second coupling ring 127 rotates in the state of being inserted into the first coupling ring 111, each stopping jaw 128 moves radially with respect to each guide jaw 112, and the plurality of stopping jaws 128 may be completely engaged with the plurality of guide jaws 112. In this case, the second power receiving coil 140b and the power transmitting coil 150 may be completely overlapped. In other words, the second power receiving coil 140b and the power transmitting coil 150 may form a maximum overlapped area (OA).

A plurality of second power receiving coils 140b, as illustrated in FIG. 11, may be formed on the lateral surface of the lid 120, and a plurality of power transmitting coils 150 may be formed on the lateral surface of the main body 110. In this case, the number of the second power receiving coils 140b and the number of the power transmitting coils 150 may be the same.

The plurality of second power receiving coils 140b, and the plurality of power transmitting coils 150 at positions corresponding to positions of the plurality of second power receiving coils 140b may form an overlapped area (OA) respectively. The overlapped area (OA) formed between the second power receiving coil 140b and the power transmitting coil 150 is described above based on a single second power receiving coil 140b and a single power transmitting coil 150, and the above description may be applied to the plurality of coils illustrated in FIG. 11. Accordingly, detailed description in relation to this is omitted.

The rotation-coupling, as described above, may be any coupling by which the lid 120 is coupled to or decoupled from the main body 110 by horizontally rotating with respect to the upper surface of the main body 110. In some implementations, even in a structure different from the structure in FIG. 4, the main body 110 and the lid 120 may be incompletely coupled before the lid 120 rotates with respect to the upper surface of the main body 110 to a predetermined angle, and the main body 110 and the lid 120 may be completely coupled when the lid 120 rotates with respect to the upper surface of the main body 110 to a predetermined angle.

In this case, as a rotation angle of the lid 120 becomes greater, a width of the overlapped area (OA) may become wider, and then when the lid 120 is completely rotation-coupled to the main body 110, the width of the overlapped area (OA) may be maximized.

An amount of electric currents induced to the second power receiving coil 140b may be proportional to a surface area of the overlapped area (OA). In some examples, the amount of electric currents may be measured in a unit of current such as Ampere, mA, μA, etc. In some examples, the amount of electric currents may be measured in a unit of voltage corresponding to the electric currents.

In some examples, an amount of electric currents induced to the second power receiving coil 140b through the process of electromagnetic induction may be proportional to a coupling factor between the second power receiving coil 140b and the power transmitting coil 150.

The coupling factor between the two coils may become higher as the width of the overlapped area (OA) becomes wider. In some implementations, an amount of electric currents induced to the second power receiving coil 140b may be proportional to the surface area of the above-described overlapped area (OA).

The control module 121 may determine a coupling state of the lid 120 based on an amount of electric currents induced to the second power receiving coil 140b.

The overlapped area (OA), as described above, may form a different surface area according to rotation of the lid 120, and the amount of electric currents induced to the second power receiving coil 140b may be proportional to a surface area of the overlapped area (OA). In some implementations, the amount of electric currents induced to the second power receiving coil 140b may vary according to rotation of the lid 120.

The control module 121 may find out a degree of rotation of the lid 120 based on the amount of electric currents induced to the second power receiving coil 140b. By doing so, the control module 121 may indirectly determine a state of coupling of the lid 120 to the main body 110. The coupling state may be classified as a normal state and an abnormal state.

In some examples, the normal state may be when the lid is placed to a predetermined position relative to the main body, and the abnormal state may be when the lid is placed to a position offset from the predetermined position relative to the main body. For instance, the lid may be configured to, in the normal state, completely close or be coupled to an upper surface of the main body to thereby define an internal space to cook food items in the main body.

In some implementations, when the amount of electric currents induced to the second power receiving coil 140b is a maximum amount of electric currents, the control module 121 may determine that the coupling state is a normal state, and, when the amount of electric currents induced to the second power receiving coil 140b is less than a maximum amount of electric currents, the control module 121 may determine that the coupling state is an abnormal state.

The control module 121 may detect an amount of electric currents induced to the second power receiving coil 140b. Any current sensor or any current detection circuit may be used for the operation of detecting an amount of electric currents performed by the control module 121.

As described with reference to FIGS. 8B and 10B, when the lid 120 is completely rotation-coupled to the main body 110, the width of the overlapped area (OA) between the second power receiving coil 140b and the power transmitting coil 150 may be maximized. In this case, an amount of electric currents induced to the second power receiving coil 140b may be a maximum amount.

In some implementations, the control module 121 may identify a preset maximum amount of electric currents with reference to an internal memory, and may compare an amount of electric currents induced to the second power receiving coil 140b with the identified maximum amount of electric currents.

As a result of comparison, when an amount of electric currents induced to the second power receiving coil 140b is the same as the maximum amount of electric currents, the control module 121 may consider that the lid 120 is completely rotation-coupled to the main body 110 and may determine that the coupling state is a normal state. When an amount of electric currents induced to the second power receiving coil 140b is less than the maximum amount of electric currents, the control module 121 may consider that the lid 120 is incompletely rotation-coupled to the main body 110 and may determine that the coupling state is an abnormal state.

As another example, when an amount of electric currents induced to the second power receiving coil 140b is greater than a reference amount of electric currents, the control module 121 may determine that the coupling state is a normal state, and, when an amount of electric currents induced to the second power receiving coil 140b is less than the reference amount of electric currents, the control module 121 may determine that the coupling state is an abnormal state.

As described above, the width of the overlapped area (OA) may be maximized when the lid 120 is completely rotation-coupled to the main body 110. However, the wireless induction heating cooker 100 may perform cooking operations even when the lid 120 is incompletely rotation-coupled to the main body 110, specifically, even when the stopping jaw 128 in FIG. 4 is incompletely engaged with the guide jaw 112.

In other words, even when the lid 120 is rotated to a predetermined angle with respect to the main body 110 and is coupled to the main body 110, the lid 120 may be designed to tolerate high pressures generated in the internal pot 130 during cooking.

In this case, the control module 121 may determine a coupling state by comparing an amount of electric currents induced to the second power receiving coil 140b with the reference amount of electric currents. The reference amount of electric currents may be set by the user at random, and, for example, may be set to 90% of the above-described maximum amount of electric currents.

When an amount of electric currents induced to the second power receiving coil 140b is greater than the reference amount of electric currents and less than the maximum amount of electric currents, the control module 121 may consider that the lid 120 is rotation-coupled to the main body 110 to the extent that cooking operations may be performed, and may determine that the coupling state is a normal state. When an amount of electric currents induced to the second power receiving coil 140b is less than the reference amount of electric currents, the control module 121 may consider that the lid 120 is not rotation-coupled to the main body 110 to the extent that cooking operations may be performed, and may determine that the coupling state is an abnormal state.

The present disclosure, as described above, may electrically find out whether the main body 110 and the lid 120 are normally coupled, without an additional physical component, thereby accurately detecting a coupling state of the lid with no increase in production costs and with no decrease in productivity.

When the coupling state of the lid 120 is an abnormal state, the control module 121 may supply an output control signal to the display module 123, and the display module 123 may output abnormality information according to the output control signal.

The abnormality information may be any information that tells the coupling state of the lid 120 is an abnormal state. The abnormality information, for example, may be text and image information for requesting the user to normally couple the lid 120.

Specifically, when determining the coupling state of the lid 120 is an abnormal state, the control module 121 may supply an output control signal, which is a digital signal, to the display module 123. The display module 123 may receive the output control signal from the control module 121, may identify abnormality information corresponding to the output control signal with reference to the internal memory, and may output the identified abnormality information visually.

The present disclosure, as described above, may inform the user about an abnormal coupling between the main body 110 and the lid 120, thereby preventing an explosion or a fire during cooking, caused by an abnormal coupling of the lid 120.

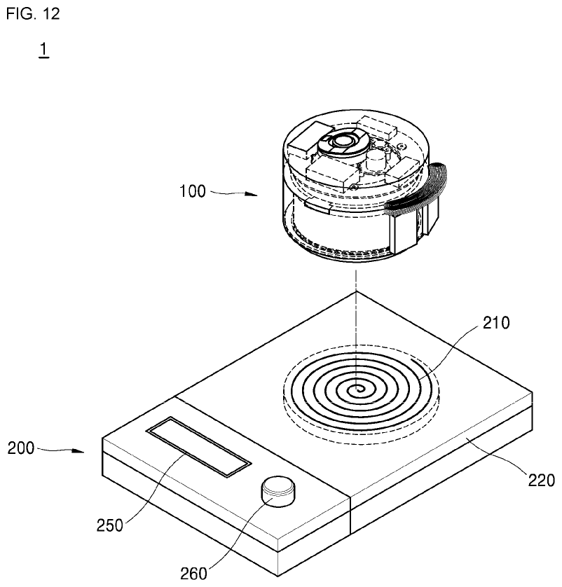

Next, an exemplary wireless induction heating system is described with reference to FIGS. 6 and 12.

FIG. 12 is a view illustrating an exemplary wireless induction heating system.

Referring to FIG. 12, the exemplary wireless induction heating system 1 may include an induction heating apparatus 200, and a wireless induction heating cooker 100 that operates on the induction heating apparatus 200. The wireless induction heating cooker 100 of the wireless induction heating system 1 may be the same as or similar to the wireless induction heating cooker described with reference to FIGS. 2 to 11 above. Thus, differences from the wireless induction heating cooker 100 may be described below.

The induction heating apparatus 200, as illustrated in FIG. 6, may include a main PCB, and a heating coil 210 that generates a magnetic field according to control by the main PCB. Specifically, the induction heating apparatus 200 may be connected to an external power source, and the main PCB in the induction heating apparatus 200 may supply electric currents to the heating coil 210, using the external power source. When the electric currents are supplied to the heating coil 210, a magnetic field may be generated in the heating coil 210.

In some implementations, the induction heating apparatus 200, as illustrated in FIG. 12, may include a display 250 and a knob switch 260. In some examples, the induction heating apparatus 200 may further include a communicator that performs data communication with the communication module 122 of the wireless induction heating cooker 100. The communicator may include an electrical circuit. The display 250, the knob switch 260 and the communicator may be electrically connected to the main PCB and may be controlled by the main PCB, or may supply a signal to the main PCB.

The knob switch 260 may be provided on an upper surface of the induction heating apparatus 200, and may supply a signal according to degrees of rotation of the knob switch to the main PCB. The main PCB may determine an output from the heating coil 210 according to the signal supplied by the knob switch 260. In other words, an amount of electric currents supplied to the heating coil 210 may be controlled according to the degrees of rotation of the knob switch 260.

The wireless induction heating cooker 100 may include a main body 110, and a lid 120 that is rotation-coupled to the main body 110. The main body 110 and the lid 120 are described above. Accordingly, detailed description in relation to this is omitted.

The wireless induction heating cooker 100 may operate on an area formed by the heating coil 210. The area formed by the heating coil 210 may be a minimum area that may include all parts of the heating coil 210. For example, when the heating coil 210 is a planar circular coil, a surface of the area formed by the heating coil 210 may be a surface of a circle determined by a coil radius that is a distance from a center of the heating coil 210 to an outer circumferential surface of the heating coil 210.

The wireless induction heating cooker 100 may perform cooking operations using a magnetic field generated in the heating coil 210. The cooking operations may include entire operations of the control module 121, the communication module 122 and the display module 123 in FIG. 6 as well as an operation of cooking an item subject to cooking through heating of the internal pot.

In some implementations, the wireless induction heating cooker 100 may determine a coupling state of the lid 120 based on an amount of power received through the heating coil 210. Specifically, the wireless induction heating cooker 100 may determine a coupling state of the lid 120 based on an amount of electric currents induced to the second power receiving coil 140b in FIG. 6. In some examples, the power may be transferred from the heating coil 210 to the to the second power receiving coil 140b through the first power receiving coil 140a and the power transmitting coil 150. The process of determining a coupling state is described above. Detailed description in relation to this is omitted.

The induction heating apparatus 200 and the wireless induction heating cooker 100 may share state information by performing mutual data communication. The induction heating apparatus 200 may control output from the heating coil 210 based on state information of the wireless induction heating cooker, and the wireless induction heating cooker 100 may control an internal electronic device based on the state information of the induction heating apparatus 200.

For example, when the control module 121 determines that the coupling state of the lid 120 is an abnormal state, the wireless induction heating cooker 100 may transmit an abnormality signal to the induction heating apparatus 200 through the communication module 122. The induction heating apparatus 200 may receive the abnormality signal through the communicator, and the main PCB may control the display 250 and may output abnormality information visually based on the received abnormality signal.

The present disclosure described above may be replaced, modified and changed in various different forms by one having ordinary skill in the art to which the present disclosure pertains without departing from the technical spirit of the disclosure. Thus, the disclosure is not limited to the above-described implementations and the accompanying drawings.

What is claimed is:

1. A wireless induction heating cooker configured to operate on an induction heating apparatus, the wireless induction heating cooker comprising:
a main body having an upper surface that defines an opening;
a lid that is configured to rotate relative to the main body to thereby couple to the upper surface of the main body;
an internal pot that is configured to be received in the main body and that is configured to be heated by induction based on a first magnetic field being generated by a heating coil of the induction heating apparatus;
a first power receiving coil disposed at a bottom surface of the main body and configured to generate a first electric current based on induction by the first magnetic field;
a power transmitting coil disposed at a lateral surface of the main body and configured to receive the first electric current induced to the first power receiving coil, the power transmitting coil being configured to generate a second magnetic field based on receiving the first electric current;
a second power receiving coil disposed at a lateral surface of the lid and configured to generate a second electric current based on induction by the second magnetic field; and
a control module that is configured to determine a coupling state between the lid and the main body based on an amount of the second electric current induced to the second power receiving coil.

2. The wireless induction heating cooker of claim 1, further comprising:
a first coupling ring disposed at the upper surface of the main body; and
a second coupling ring that is disposed at a lower surface of the lid and that is configured to rotate relative to the first coupling ring to thereby couple to the first coupling ring.

3. The wireless induction heating cooker of claim 2, wherein the first coupling ring defines a groove that is depressed from the upper surface of the main body, and
wherein the second coupling ring comprises a protrusion that protrudes from the lower surface of the lid and that is configured to be inserted into the groove of the first coupling ring and then rotated relative to the first coupling ring to thereby couple the second coupling ring to the first coupling ring.

4. The wireless induction heating cooker of claim 3, wherein the first coupling ring comprises a plurality of guide jaws, and
wherein the second coupling ring comprises a plurality of stopping jaws that are configured to engage with the plurality of guide jaws based on the second coupling ring being inserted into the groove of the first coupling ring and rotated relative to the first coupling ring.

5. The wireless induction heating cooker of claim 1, wherein the first power receiving coil is arranged in parallel to the heating coil and faces a lower portion of an edge area of the internal pot.

6. The wireless induction heating cooker of claim 1, wherein the lid comprises one or more electronic devices, and
wherein the second power receiving coil is configured to supply the second electric current to at least one of the one or more electronic devices.

7. The wireless induction heating cooker of claim 6, wherein the one or more electronic devices in the lid comprise at least one of a control module, a communication module, a display module, a steam discharge module, or a battery.

8. The wireless induction heating cooker of claim 1, further comprising:
a power conversion circuit configured to convert the first electric current induced to the first power receiving coil and to supply the converted first electric current to the power transmitting coil.

9. The wireless induction heating cooker of claim 1, wherein the power transmitting coil is disposed at an upper portion of the main body and extends along an outer surface of the main body, the power transmitting coil having a first length along the outer surface of the main body, and
wherein the second power receiving coil extends along an outer surface of the lid, the second power receiving coil having a second length along the outer surface of the lid.

10. The wireless induction heating cooker of claim 1, wherein the power transmitting coil extends along a cylindrical surface of the main body and is disposed within an area defined by a first central angle with respect to a center of the main body, and
wherein the second power receiving coil extends along a cylindrical surface of the lid and is disposed within an area defined by a second central angle with respect to a center for the lid.

11. The wireless induction heating cooker of claim 1, wherein sizes of the power transmitting coil and the second power receiving coil are identical to each other, and
wherein shapes of the power transmitting coil and the second power receiving coil are identical to each other.

12. The wireless induction heating cooker of claim 1, wherein the second power receiving coil and the power transmitting coil are configured to, based on the lid rotating relative to the main body, overlap with each other and define an overlapped area.

13. The wireless induction heating cooker of claim 12, wherein the amount of the second electric current induced to the second power receiving coil is configured to vary proportional to a surface area of the overlapped area.

14. The wireless induction heating cooker of claim 1, wherein the control module is configured to:
based on the amount of the second electric current being greater than or equal to a reference amount of electric current, determine that the coupling state is a normal state; and
based on the amount of the second electric current being less than the reference amount of electric current, determine that the coupling state is an abnormal state.

15. The wireless induction heating cooker of claim 1, wherein the control module is configured to:
based on the amount of the second electric current corresponding to a maximum amount of electric current during a rotation of the lid relative to the main body, determine that the coupling state is a normal state; and
based on the amount of the second electric current being less than the maximum amount of electric current, determine that the coupling state is an abnormal state.

16. The wireless induction heating cooker of claim 7, wherein the control module is configured to, based on the coupling state corresponding to an abnormal state, supply an output control signal to the display module, and
wherein the display module is configured to output abnormality information according to the output control signal.

17. The wireless induction heating cooker of claim 1, further comprising:
a lateral surface heating coil that is disposed on an outer circumferential surface of the internal pot, that is connected to the first power receiving coil, and that is configured to heat the internal pot using the first electric current induced to the first power receiving coil.

18. The wireless induction heating cooker of claim 1, wherein the second power receiving coil is configured to, based on the coupling state corresponding to a normal state, face the power transmitting coil in a vertical direction with respect to the bottom surface of the main body or in a circumferential direction along the lateral surface of the main body.

19. A wireless induction heating system, comprising:
an induction heating apparatus comprising a main printed circuit board (PCB) and a heating coil that is configured to generate a first magnetic field according to control by the main PCB; and
a wireless induction heating cooker comprising a main body and a lid, the lid being configured to rotate relative to the main body to thereby couple to the main body and to cook food items by induction based on the first magnetic field being generated by the heating coil,
wherein the wireless induction heating cooker is configured to determine a coupling state between the lid and the main body based on an amount of power transferred from the heating coil.

20. The wireless induction heating system of claim 19, wherein the wireless induction heating cooker further comprises:
an internal pot that is configured to be received in the main body and that is configured to be heated by induction based on the first magnetic field being generated by the heating coil of the induction heating apparatus;
a first power receiving coil disposed at a bottom surface of the main body and configured to generate a first electric current based on induction by the first magnetic field;
a power transmitting coil disposed at a lateral surface of the main body and configured to receive the first electric current induced to the first power receiving coil, the power transmitting coil being configured to generate a second magnetic field based on receiving the first electric current;
a second power receiving coil disposed at lateral surface of the lid and configured to generate a second electric current based on induction by the second magnetic field; and
a control module configured to determine the coupling state based on an amount of the second electric current induced to the second power receiving coil.
